(19) United States
(12) Patent Application Publication
(10) Pub. No.: US 2026/0261509 A1
(43) Pub. Date: Sep. 3, 2026

(54) Unique Identifier for Reverse Path Forwarding with Multicast VPNs

(71) Applicant: Ciena Corporation, Hanover, MD (US)

(72) Inventors: Nikhil Sanjeev Kulkarni, San Jose, CA (US); Ramkumar Parameswaran, San Jose, CA (US); Sami Boutros, Union City, CA (US); Mourad Atassi, San Ramon, CA (US)

(73) Assignee: Ciena Corporation, Hanover, MD (US)

(21) Appl. No.: 19/068,123

(22) Filed: Mar. 3, 2025

(51) Int. Cl. H04L 45/48; H04L 45/02; H04L 45/50

(52) U.S. Cl. CPC H04L 45/48; H04L 45/02; H04L 45/50

(57) ABSTRACT

In a multicast VPN, Reverse Path Forwarding (RPF) checks are critical for preventing loops and duplicate traffic. Traditional RPF solutions rely on specific interfaces or IP next‐hops, which can fail in complex or dynamic environments. This disclosure introduces a universally unique identifier (UUID) that binds incoming multicast traffic to a logical distribution tree, regardless of physical or label‐based routes. A transport identifier, such as an MPLS label, is mapped to the UUID, and upon arrival, the receiving node consults the UUID for RPF validation within a VRF table. If the packet’s UUID matches that of the multicast route entry, it is forwarded; otherwise, it is dropped. This method decouples RPF checks from physical interfaces or label assignments, simplifying configuration, adapting to diverse underlay technologies, and improving reliability in large‐scale or frequently changing multicast VPN networks.

### FIELD OF DISCLOSURE

The present disclosure relates generally to networking and computing. More particularly, the present disclosure relates to systems and methods for a unique identifier for reverse path forwarding (RPF) with multicast virtual private networks (VPNs).

Reverse Path Forwarding (RPF) is used in multicast routing to ensure that traffic travels along the correct path, thereby preventing routing loops and duplicate traffic forwarding. This process involves checking whether a packet arrives on the interface that would be used to send traffic back to the source. If the incoming interface passes the RPF check, the packet is forwarded on to other interfaces; if it fails, the packet is dropped. By verifying the path in reverse, RPF maintains efficient and accurate distribution of multicast data and helps preserve network performance. This approach works well in simpler multicast environments where traffic always arrives from the same source interface. However, in more complex or dynamic multicast VPNs, relying on a single, fixed interface or IP route for RPF can lead to suboptimal routing, routing loops, blackhole routes, or inconsistent forwarding if the primary path fails or changes. Frequent route flaps or shifts in network topology can further disrupt multicast streams, introducing latency and undermining reliability. As a result, purely static RPF checks may struggle to accommodate the flexibility and scale required in evolving multicast VPN environments.

Example specifications include RFC 6513, Multicast in MPLS/BGP IP VPNs, February 2012; RFC 6514, BGP Encodings and Procedures for Multicast in MPLS/BGP IP VPNs, February 2012; and RFC 6388, Label Distribution Protocol Extensions for Point-to-Multipoint and Multipoint-to-Multipoint Label Switched Paths, November 2011, the contents of each are incorporated by reference in their entirety.

### BRIEF SUMMARY OF THE DISCLOSURE

Multicast routing employs RPF checks to ensure that traffic arrives via the correct path from its source, preventing loops and duplicate forwarding. In simpler networks, RPF logic typically ties directly to an interface or IP route. However, large or dynamic Multicast VPNs often experience route changes, multiple potential paths, and overlapping label spaces; as a result, relying on a single interface or label can lead to blackholes, loops, and complex configuration demands. The present disclosure introduces a Universally Unique Identifier (UUID) as an abstract handle for each multicast distribution tree. Rather than binding RPF to a specific interface or IP‐based path, each packet is associated with the UUID of its multicast tree, enabling robust and uniform RPF checks even if underlay transport labels or physical interfaces change. This approach not only simplifies RPF consistency across complex networks but also improves scalability, fault tolerance, and future‐proofing, as the UUID can be mapped flexibly to different underlay technologies and dynamically updated route paths.

In various embodiments, the present disclosure contemplates implementation as a method including steps; via a network device, apparatus, router, or circuitry configured to implement the steps; and as a non-transitory computer-readable medium storing instructions that, when executed, cause circuitry to implement the steps. The steps are for performing a reverse path forwarding (RPF) check for a multicast packet in a network device. The steps include receiving a multicast packet that includes a transport identifier associated with a multicast distribution tree; retrieving a universally unique identifier (UUID) corresponding to the transport identifier; comparing the retrieved UUID to a second UUID in a multicast routing entry of a virtual routing and forwarding (VRF) table; and forwarding the multicast packet if the retrieved UUID matches the second UUID, or discarding the multicast packet otherwise, wherein the UUID provides an abstract handle for the multicast distribution tree independent of a physical interface or an Internet Protocol (IP) next‐hop.

The steps can further include, prior to the receiving, assigning the UUID to the multicast distribution tree in a control plane, wherein the UUID uniquely identifies the multicast distribution tree irrespective of transport‐layer label assignments. The steps can further include linking the UUID to a multicast group and source address for RPF checking, wherein the control plane creates a multicast route entry that includes the UUID for validating incoming packets. The steps can further include mapping the transport identifier to the assigned UUID in the control plane, wherein the network device stores the mapping in a hardware or software table accessible to a data plane. The steps can further include programming a label forwarding table or incoming label map (ILM) with the mapping of the transport identifier to the UUID, wherein a data plane references the ILM to retrieve the second UUID for incoming packets. The receiving the multicast packet can include detecting an MPLS label as the transport identifier, and the steps further include removing the MPLS label before performing UUID comparison in the VRF table.

The steps can further include updating a UUID‐to‐transport‐identifier mapping in response to route convergence or other network changes, thereby maintaining consistent RPF checks across varying paths. The network device can be an egress provider edge (PE) router in a multicast virtual private network (VPN), and the VRF table is associated with a particular VPN instance, such that the UUID also differentiates multiple multicast trees in a same underlay. The forwarding the multicast packet can further include replicating the multicast packet to one or more downstream nodes, and discarding the multicast packet includes performing a drop action upon detecting a UUID mismatch to prevent routing loops or duplicate traffic. The steps can further include generating in a control plane a programmable instruction linking the transport identifier, an assigned UUID, and a hardware identifier for line‐rate lookups; and installing the programmable instruction into a data plane via a hardware abstraction layer (HAL) or software development kit (SDK), wherein the data plane enforces UUID‐based RPF checks at forwarding time. The steps can further include storing the assigned UUID in a software layer of the network device, wherein upon receiving the multicast packet, the data plane consults a hardware table that references the UUID to execute the RPF check at line rate.

### BRIEF DESCRIPTION OF THE DRAWINGS

The present disclosure is illustrated and described with reference to the accompanying drawings. Unless otherwise specified, the drawings are not necessarily drawn to scale, and certain features or components may be enlarged, exaggerated, or omitted for clarity. Like reference numerals are used throughout to denote like components or steps, as appropriate.

FIG. 1 illustrates two multicast trees originating from separate root nodes.

FIG. 2 illustrates a logical diagram of an egress provider edge (PE) router receiving two differently‐labeled multicast (or VPN) flows.

FIG. 3 illustrates a diagram of a provisioning model for provisioning the UUID.

FIG. 4 illustrates two flowcharts of two example multicast packets arriving with different MPLS labels and how the system performs an RPF check based on a UUID (or hardware identifier) rather than a fixed physical interface.

FIG. 5 illustrates a flowchart of a process for performing a reverse path forwarding (RPF) check for a multicast packet in a network device.

FIG. 6 illustrates a block diagram of a router.

### DETAILED DESCRIPTION OF THE DISCLOSURE

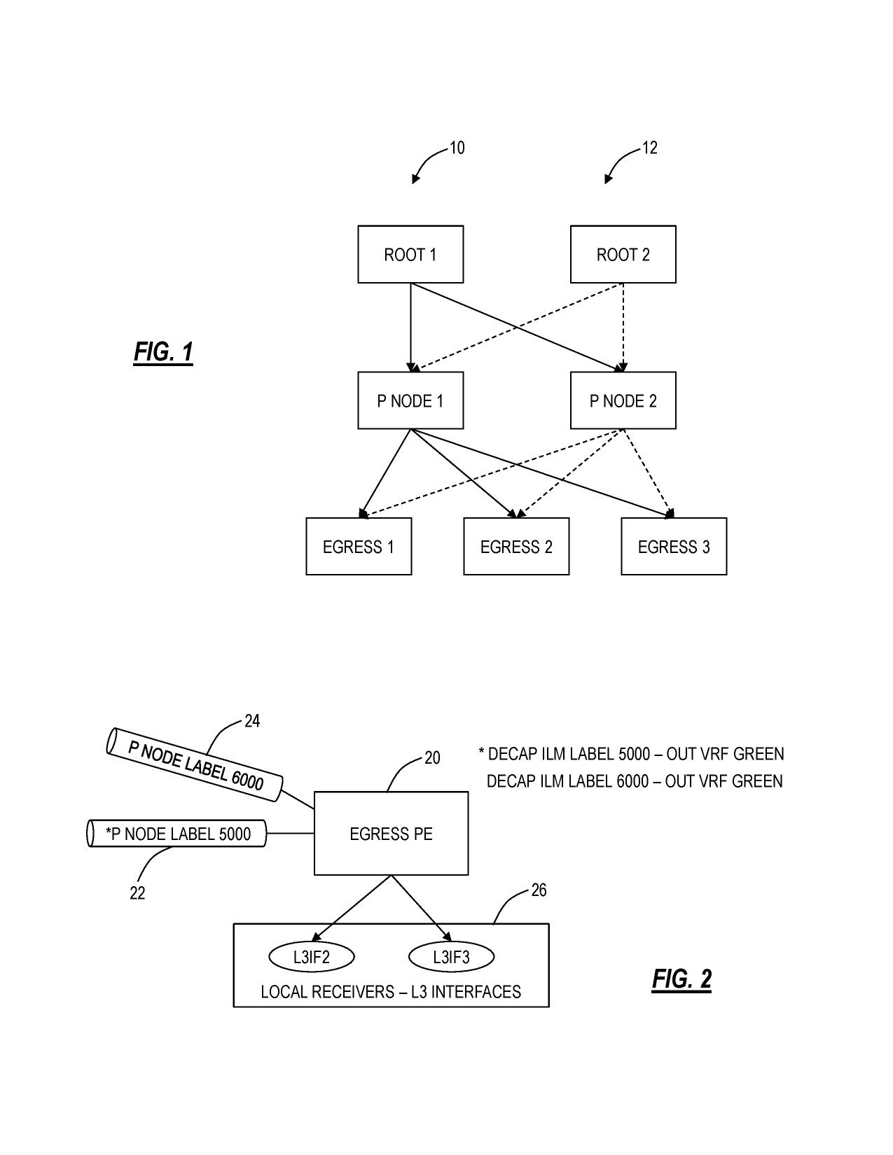

FIG. 1 illustrates two multicast trees 10, 12 originating from separate root nodes 1, 2. For example, the multicast tree 10 extends from a root 1 through a P node 1 and then fans out to egress nodes 1, 2, 3, while the multicast tree 12 extends from a root 2 through a P node 2 to the same set of egress nodes 1, 2, 3. Each of these nodes - roots 1, 2; P nodes 1, 2; and egress nodes 1, 2, 3 - represents a router, switch, or other network device that supports multicast routing (including multicast VPNs). These network elements include the circuitry and ports necessary for packet switching and routing, providing multicast capabilities under various protocols and technologies.

The multicast trees 10, 12 are conceptual or logical constructs defining how multicast traffic flows from one or more source nodes (the roots 1, 2) downstream through intermediate routers (the P nodes 1, 2) to a set of egress (leaf) nodes (egress 1, 2, 3), each of which delivers the traffic to local receivers. Although these trees 10, 12 appear as straightforward root‐to‐leaf hierarchies, they operate over a physical network topology composed of interconnected nodes and interfaces. Each router or switch connects via one or more Layer 3 or Layer 2 interfaces, forming the actual paths that carry the multicast packets. As a result, while the multicast trees 10, 12 exist logically - mapping out who forwards traffic to whom - the underlying infrastructure is a mesh of devices, ports, and links that must accurately forward and replicate data in accordance with each logical distribution tree.

In FIG. 1, roots 1, 2 serve as the head‐ends (or sources) for their respective multicast trees 10, 12, where the tree 10 originates at root 1 and the tree 12 originates at root 2. From these head‐ends, multicast traffic is forwarded downstream to other nodes in each tree 10, 12. The P nodes 1, 2, which act as provider or transit routers, lie between the root nodes and the egress (leaf) nodes 1, 2, 3. Their role is to receive the multicast stream from the roots 1, 2 and replicate or forward it to the relevant egress nodes 1, 2, 3. Depending on the network design, a single P node may handle one or both multicast trees 10, 12, maintain separate forwarding states for each, and handle different multicast group addresses.

The egress nodes 1, 2, 3 are the “leaves” or termination points of the multicast trees 10, 12. They receive the replicated traffic from the upstream P nodes 1, 2 and deliver it to local receivers, customer networks, or both. Each egress node 1, 2, 3 can subscribe to one or more of the multicast groups traversing trees 10, 12, ensuring that traffic is distributed only to endpoints that have explicitly requested it. Altogether, these nodes demonstrate how each multicast tree 10, 12 grows from a single source node through transit (provider) routers to reach a set of downstream endpoints, thereby providing efficient, scalable distribution of multicast traffic. Naturally, FIG. 1 depicts a simplified scenario with just two multicast trees 10, 12 and a limited number of routers; in practical deployments, many more roots, P nodes, egress nodes, and multicast groups may be involved.

In a typical multicast environment, all transit nodes in each of the trees 10, 12, e.g., such as the provider (P) nodes 1, 2, perform RPF checks. Any egress node 1, 2, 3 that also forwards traffic (for example, in a hub‐and‐spoke or hierarchical design) would similarly verify RPF. When a P node 1, 2 or egress node 1, 2, 3 receives a multicast packet, it inspects the source address and consults its unicast routing table to determine which interface it would use to reach the source (i.e., the corresponding root 1, 2). If the packet arrives on that same “correct” interface, the RPF check passes, and the node forwards the multicast data downstream or processes the packet. If the packet arrives on a different interface, the RPF check fails, and the P node 1, 2 discards the packet to avoid loops and duplicate forwarding.

However, problems arise when relying solely on interface checks, especially in networks supporting multiple multicast trees 10, 12 or dynamic routing paths. For instance, a P node 1, 2 and the egress nodes 1, 2, 3 may employ distinct interfaces to reach different sources (root 1 versus root 2). If the “wrong” tree’s traffic arrives on an interface that the P node associates with another root, the RPF check will fail, and the traffic will be dropped.

In large networks, particularly in multicast VPNs, route updates or changes can stem from a variety of factors such as dynamic routing protocol adjustments, sudden shifts in link metrics (e.g., cost or bandwidth), failover events, multiprotocol label switching (MPLS) traffic‐engineering reroutes, or even the introduction of new virtual routing and forwarding (VRF). For instance, if a core link experiences congestion or a temporary outage, routing protocols like border gateway protocol (BGP) might reconverge and select a different path for multicast traffic. When these updates are frequent - sometimes termed route flaps - the P node's 1, 2 or egress node's 1, 2, 3 “expected” interface or next‐hop can quickly become outdated. As a result, multicast packets arriving on a newly chosen interface may appear to fail the RPF check, causing blackholes (where packets are silently dropped) or inconsistent forwarding if multiple valid interfaces exist. Operators often face the challenge of fine‐tuning convergence timers, configuring multiple RPF interfaces, or employing policy‐based routing rules to keep pace with these dynamic changes, adding significant complexity and increasing the likelihood of misconfiguration.

In multicast routing, RPF checks ensure that multicast traffic is received on the interface matching each node’s view of the distribution tree. Without RPF checks, (1) transient routing changes or (2) loops could cause duplicate packets and packet storms, overwhelming network links and degrading overall performance (including unicast flows).
(1) Transient Routing Changes: When the link metric changes, multicast traffic may temporarily traverse multiple paths. The egress nodes 1, 2, 3 could receive duplicate packets via different interfaces; an RPF check discards the copies that do not match the node’s local forwarding view.
(2) Potential Loops: In dynamic or failover scenarios, looping paths can inadvertently form (for example, root 1 → P node 1 → egress 1 → P node 2 → egress 2 → P node 1 → egress 1). RPF checks detect and discard any looped traffic, preventing flooding that would saturate links.

In a Multicast VPN environment, however, the “interface” on which traffic appears is effectively a multicast tunnel (e.g., MPLS‐based tunnels such as multicast label distribution protocol (mLDP), ingress replication, point-to-multipoint (p2mp) Resource Reservation Protocol-Traffic Engineering (RSVP-TE), p2mp Segment Routing-Traffic Engineering (SR-TE), protocol independent multicast (PIM), etc.). Packets can arrive via any physical Layer 3 interface, but from a routing perspective they are associated with a specific multicast tree tunnel. Consequently, each multicast route on an egress node 1, 2, 3 must map back to the correct tunnel for RPF checking.

Traditionally (absent this disclosure), an RPF check is tied to a specific physical interface or an IP next‐hop. This method works well in simpler multicast environments where traffic consistently arrives via the same source interface. However, in more complex or dynamic multicast VPNs, relying on a single, fixed interface or IP route for RPF leads to various issues:
(1) Routing Changes Break RPF: If the network shifts traffic to a different physical interface, the node’s “expected interface” may no longer match the interface where packets actually arrive. Valid traffic might be dropped, or duplicates might be accepted if the node cannot reconcile two arrival interfaces for the same flow.
(2) Multiple Potential Ingress Interfaces: In a VPN or multi‐access setup, an egress node can legitimately receive the same multicast tree via multiple physical links, such as in FIG. 1. A single‐interface RPF rule fails if traffic arrives on an alternate link, causing either erroneous drops or unwanted duplicates.
(3) Complex Configuration: Operators must manually configure or dynamically monitor an “RPF interface” for each multicast route. In large‐scale topologies where paths can traverse numerous provider nodes, this becomes cumbersome and prone to misconfigurations.
(4) Challenges Adapting to Multiple Underlays: If the underlying transport changes (e.g., from MPLS to a different tunneling technology), interface‐based RPF logic must be redesigned because it is tightly linked to specific IP next‐hops or local interfaces.

FIG. 2 illustrates a logical diagram of an egress provider edge (PE) router 20 receiving two differently‐labeled multicast (or VPN) flows 22, 24, from a “P node Label 5000” path (flow 22) and a “*P node Label 6000” path (flow 24), and decapsulating each incoming flow 22, 24 onto a same VRF 26 inside the PE router 20. Specifically, two incoming labels (5000 and 6000) arrive at the egress PE 20 from upstream nodes or MPLS tunnels (not shown). Each label is associated with a value from ILM (e.g., label 5000, label 6000). The egress PE 20 decapsulates (removes the MPLS label) and forwards both flows out the same VRF (“green”). Finally, the PE 20 delivers the traffic to local receivers attached to Layer 3 interfaces (l3if2, l3if3) in the VRF 26. FIG. 2 highlights that multiple MPLS‐labeled streams, each potentially coming from different P nodes or different paths, can terminate on a single egress PE 20, where labels are mapped to specific logical interfaces. After the decapsulation step, all traffic is routed within the VRF 26, and then forwarded out to local interfaces and end receivers.

In summary, interface or IP route‐based RPF functions reliably for simpler multicast topologies but struggles in VPN deployments, where multiple valid paths, frequent link‐cost changes, and varied underlay technologies complicate routing decisions. Accordingly, employing a UUID or similar identifier to represent a logical multicast tree - regardless of physical interface - alleviates the aforementioned operational challenges.

A Universally Unique Identifier (UUID) is introduced as an abstract handle for each multicast distribution tree. Rather than relying on a traditional interface reference for RPF checks, the system associates incoming packets with a specific multicast tunnel by using the UUID in place of the interface. Each multicast VPN tree (or tunnel) is assigned a unique UUID, and both the control plane and data plane use that UUID - rather than a physical or IP‐based interface - to identify the tree.

In the network underlay (e.g., mLDP, ingress replication, p2mp RSVP‐TE, PIM, p2mp SR‐TE, etc.), multicast traffic is carried via MPLS labels or similar transport identifiers. The system maps each UUID to a unique MPLS label (or other “transport identifier”), so that hardware/software can recognize the tree and perform an RPF check accordingly. If a future underlay technology is not MPLS‐based, the UUID would still map to an equivalent unique identifier in that environment, preserving the same logical abstraction.

When a multicast packet arrives, the egress PE 20 consults its UUID‐based mappings to confirm that the packet belongs to the appropriate multicast tree. If the arriving packet’s label or tunnel ID does not match the UUID expected for that multicast tree, the RPF check fails and the packet is dropped. This provides that only valid, non‐duplicate traffic proceeds to the egress interface, preventing loops and packet duplication. Because the UUID cleanly separates the concept of a “multicast distribution tree” from any physical or IP‐based path, it simplifies the forwarding logic and enforces consistent RPF checks even in dynamic or multi‐underlay scenarios - thereby avoiding multicast loops and redundant traffic in large‐scale VPN networks.

Incoming multicast packets arrive with an MPLS label, which the egress PE 20 associates with a UUID. Once the MPLS label is popped, the system performs a multicast route lookup in the VRF table. The corresponding multicast route must have the same UUID as the RPF interface; otherwise, the packet is dropped because the RPF check is deemed failed. Notably, the UUID itself is not transmitted “on the wire” within the packet; rather, it is implicitly identified via the transport mechanism (e.g., the MPLS label) carried in the underlay.

Within a multicast VPN core, multiple types of replication trees may be in use (e.g., ingress replication, p2mp RSVP‐TE, mLDP, PIM, p2mp SR‐TE). For multicast traffic received on these various tree types, the egress PE node uses the transport‐level replication tree identifier (e.g., an MPLS label) to determine two key items:(1) Which multicast VPN service instance the traffic belongs to.(2) Which UUID is used for the RPF check.

Once the system identifies the correct VRF for the multicast VPN service instance, it performs an inner multicast lookup. The matching multicast route in that VRF also has an associated UUID that indicates the “expected” tree for RPF checking (set up in the control plane and derived from the transport replication tree forwarding equivalency class (FEC) on which the traffic should arrive). If the UUIDs do not match, the packet is dropped.

This use of a UUID for the RPF check is a novel approach to solving the traditional interface‐based limitation. In practice, a software‐based lookup determines the RPF interface through the UUID, and the data plane (in hardware) is programmed accordingly. Although hardware platforms (e.g., certain chipsets) may not store an actual UUID, they hold the “chosen” RPF interface after the software logic resolves the UUID. Thus, the updated approach resides in the software layer while the forwarding plane enforces the final RPF decision.

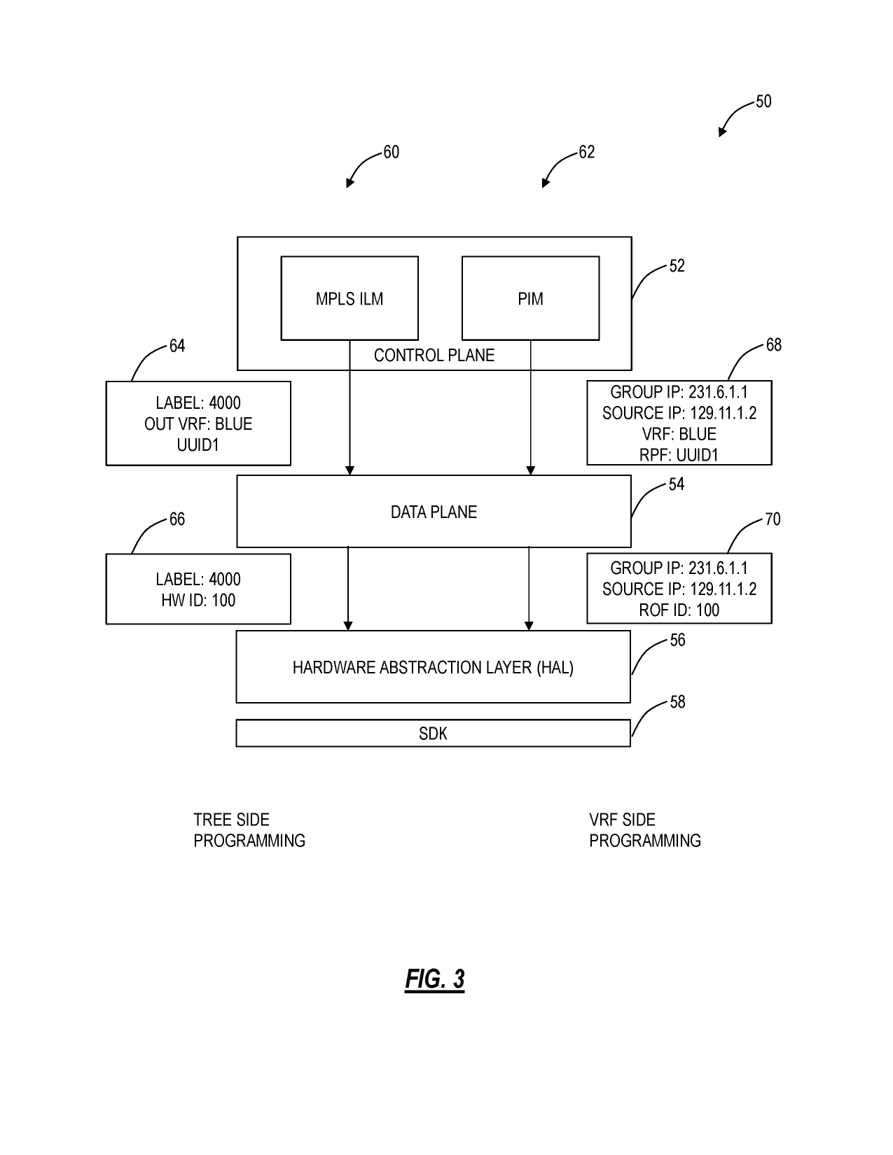

FIG. 3 illustrates a diagram of a provisioning model 50 for provisioning the UUID. This provisioning model 50 illustrates how the multicast forwarding process is configured and enforced across two main “planes” - a control plane 52 (running in software) and a data plane 54 (implemented in hardware) - with an intervening hardware abstraction layer (HAL) 56 and software development kit (SDK) 58 that programs the underlying switching/routing circuitry. The underlying switching/routing circuitry can include a packet switching or processing circuit or application specific integrated circuit (ASIC) available from a specific vendor, who in turns provides the SDK 58.

FIG. 3 illustrates the provisioning model 50 conceptually in four layers. The control plane 52 is where routing protocols (like PIM) and label management (like MPLS ILM) operate. They decide how to build the multicast trees, how to assign labels or group information, and how to link that information to a specific VRF. Once the control plane 52 determines the desired forwarding behavior (e.g., “Label 4000 → VRF Blue → UUID1”), it must write those instructions into the router’s 20 hardware tables. The HAL 56 or SDK 58 provides a set of application programming interfaces (APIs) and data structures that let the software “translate” high‐level control plane 52 decisions into the specific fields and tables used by the switching ASIC or chipset.

The data plane 54 is the actual hardware - for example, an ASIC on a router line card - that executes packet forwarding at line rate. It references the tables or entries programmed via the HAL/SDK. Here, labels and group/state IDs (such as “HW ID 100”) are matched against incoming packets.

The provisioning model 50 includes two sides 60, 62 of provisioning including transport side 60 and service side 62. In this example, the transport side 60 uses MPLS ILM and the service side 62 uses PIM, and those skilled in the art will appreciate other transport and services are contemplated. On the transport side 60, labels are assigned to the multicast tree and mapped to a VRF plus a UUID (e.g., “Label 4000 → VRF Blue → UUID1” in box 64). The hardware may store a corresponding internal identifier (e.g., “HW ID 100” in box 66) that it uses for data‐plane lookups. On the service side 62, the routing protocol (e.g., PIM) associates a multicast group (231.6.1.1), source (129.11.1.2), and VRF (Blue) with the same UUID (UUID1) (boxes 68, 70). That UUID ties the group routing entry to the transport label entry, ensuring that when a packet arrives with label 4000, the system knows it corresponds to the group/source in VRF Blue, enforced by the UUID for RPF checks.

In essence, FIG. 3 shows how the control plane 52 software (via PIM and MPLS ILM) sets up all of the mappings - labels, VRFs, and UUIDs - and then uses a hardware abstraction layer 56 or SDK 58 to program these mappings into the underlying data plane circuitry. By having both the transport side (labels/UUID) and the VRF side (group/source/UUID) reference the same unique identifiers, the hardware can forward and validate multicast packets consistently, all while decoupling logical control‐plane decisions from the actual physical interfaces and chips that move the traffic.

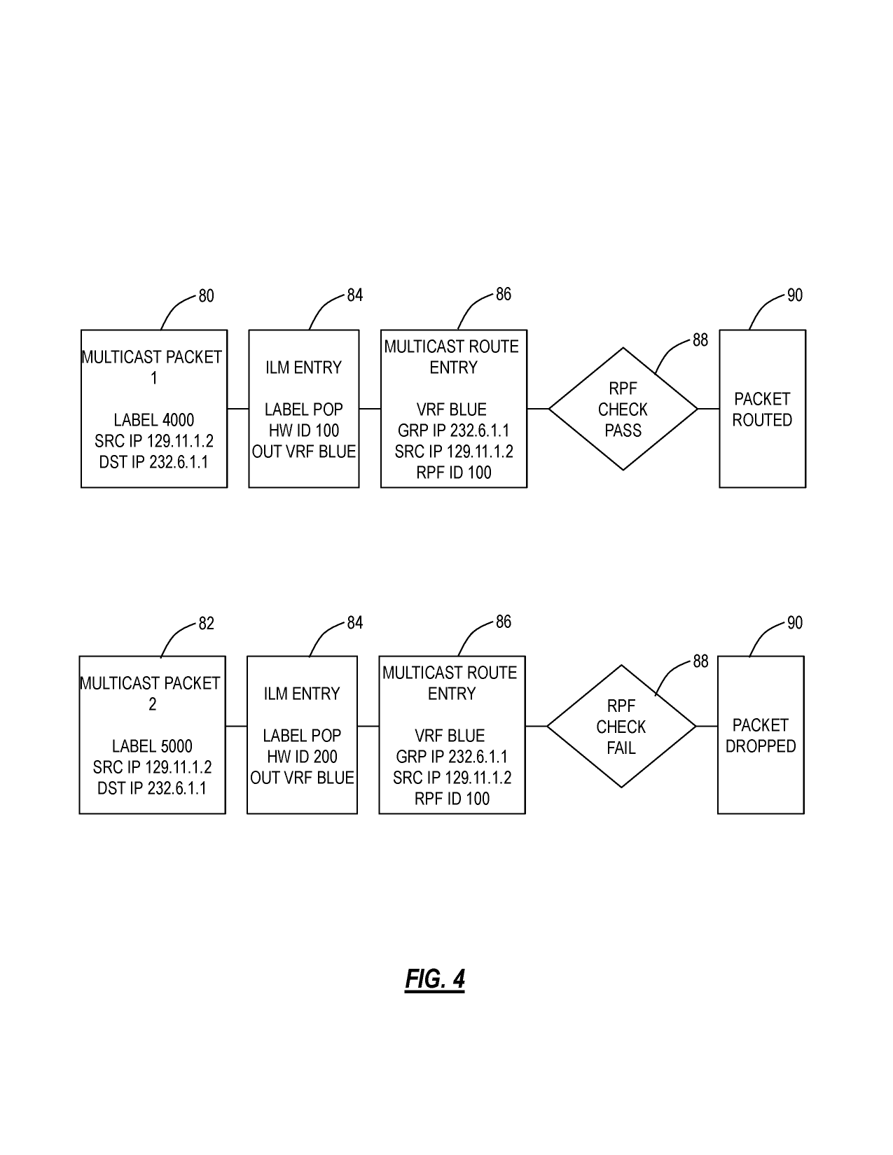

FIG. 4 illustrates two flowcharts of two example multicast packets 80, 82 arriving with different MPLS labels and how the system performs an RPF check based on a UUID (or hardware identifier) rather than a fixed physical interface. Each flow is broken down into three main steps 84, 86, 88 leading to either routing or dropping the packet 80, 82 (step 90).

The packets 80, 82 are received with labels 4000, 5000, source IP addresses, and destination addresses as listed in FIG. 4. At step 84, on the transport side, the packet’s 80, 82 MPLS label (e.g., 4000 or 5000) is mapped to an internal hardware identifier (HW ID) - 100 for label 4000 and 200 for label 5000. The label popping occurs here, and the packet is directed to the appropriate VRF (in this case, VRF Blue).

At step 86, on the service side for the multicast route entry, the system looks up the multicast group (232.6.1.1) and source (129.11.1.2) in VRF Blue, which has an associated RPF ID (the UUID). In FIG. 4, the route entry expects an RPF ID of 100 for valid traffic belonging to this (S, G) pair.

At steps 88, 90 for the RPF Check and Final Outcome:
(1) For “Packet 1” 80 with label 4000, the HW ID from the ILM is 100, which matches the route’s RPF ID of 100. The RPF check passes and the packet is forwarded.
(2) For “Packet 2” 82 with label 5000, the ILM yields HW ID 200, but the route expects RPF ID 100, so there is a mismatch. The RPF check fails and the packet is dropped.

FIG. 4 illustrates how, instead of using a single physical interface for RPF validation, the router uses MPLS labels (mapped to internal HW IDs) and UUID/RPF IDs in the multicast route entry. A match between the transport‐level HW ID and the route’s RPF ID ensures that packets are coming from the correct multicast tree (passing the RPF check). Conversely, a mismatch indicates an unexpected source path, causing the packet to be discarded.

Using the UUID rather than relying directly on a label or physical interface delivers a number of key benefits for multicast RPF checks:
(1) Decouples Control from Underlay: A UUID uniquely identifies the multicast tree, irrespective of which MPLS label (or other transport identifier) happens to be in use. If the underlay transport changes - due to route convergence, switching from MPLS to some other tunneling protocol, or even varying label assignments - the UUID still refers to the same multicast distribution tree. -
(2) Simplifies RPF Consistency: Instead of tying the RPF check to a single interface or a specific label, the router simply verifies, “Does this packet’s UUID match the UUID on the multicast route entry?” This abstract handle avoids mismatches caused by changing interfaces or label reassignments, reducing blackholes and drops.
(3) Handles Multiple Paths and Failover: When there are multiple valid paths or frequent route updates, label or interface‐based RPF can easily break if packets arrive on an unexpected interface or with a different label. With a UUID, any label or interface carrying valid traffic will still map to the same RPF “tree” ID in the control plane, preventing accidental drops or loops.
(4) Scales in Complex VPN Environments: Large multicast VPNs often involve numerous egress points, dynamic routing policies, and overlapping label spaces. A UUID provides a straightforward, logical reference to each multicast tree without forcing operators to maintain complex interface or label mappings for RPF across many nodes.
(5) Future‐Proof for Different Transports: Because the UUID is not baked into the label, interface name, or IP next‐hop, it can be mapped to whatever new transport identifier might arise. This ensures long‐term flexibility as underlay technologies evolve.

Overall, the UUID abstracts the notion of a multicast tree away from any single physical or label‐based characteristic, making RPF checks more robust, easier to manage, and less prone to disruption when underlay routes or labels change.

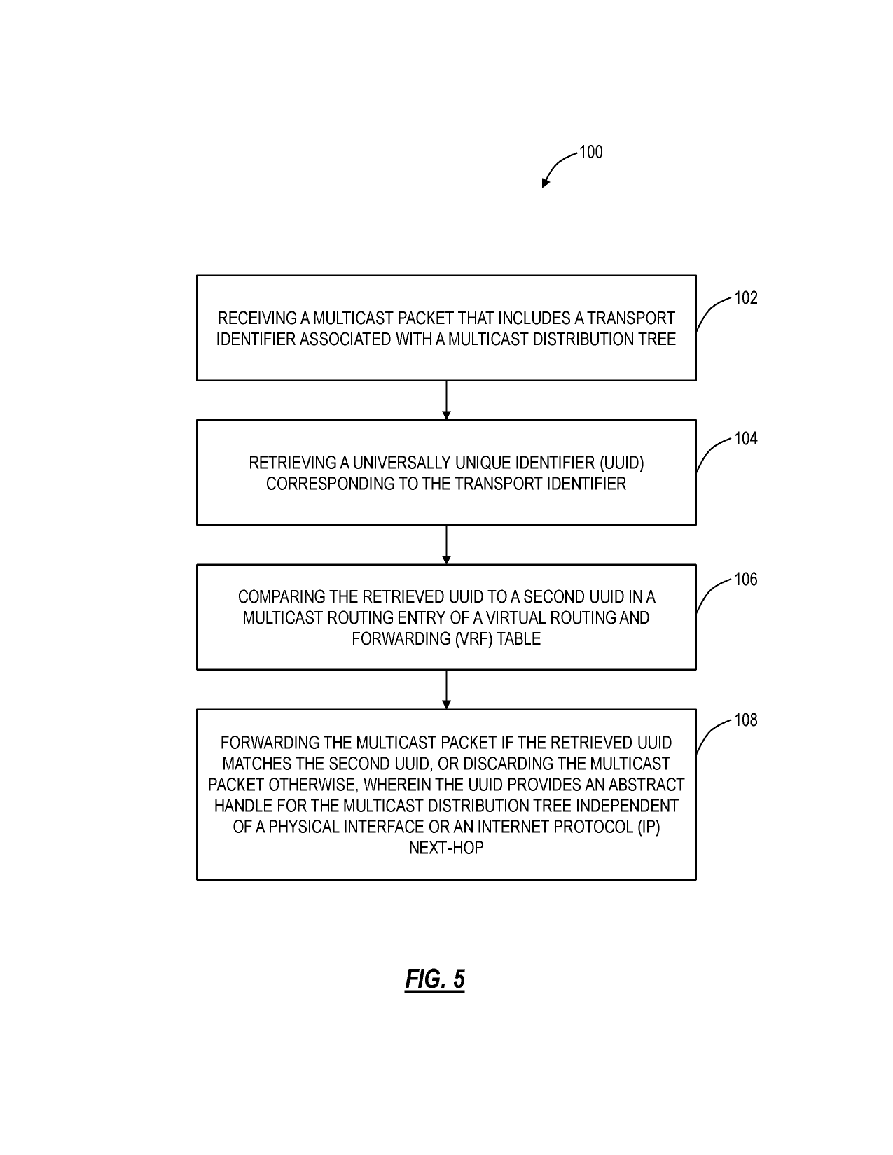

FIG. 5 illustrates a flowchart of a process 100 for performing a reverse path forwarding (RPF) check for a multicast packet in a network device. The process 100 contemplates implementation as a method with steps, via circuitry configured to implement the steps, and as a non-transitory computer-readable medium storing instructions that, when executed, cause circuitry to implement the steps.

The steps include receiving a multicast packet that includes a transport identifier associated with a multicast distribution tree (step 102); retrieving a universally unique identifier (UUID) corresponding to the transport identifier (step 104); comparing the retrieved UUID to a second UUID in a multicast routing entry of a virtual routing and forwarding (VRF) table (step 106); and forwarding the multicast packet if the retrieved UUID matches the second UUID, or discarding the multicast packet otherwise, wherein the UUID provides an abstract handle for the multicast distribution tree independent of a physical interface or an Internet Protocol (IP) next‐hop (step 108).

The steps can further include, prior to the receiving, assigning the UUID to the multicast distribution tree in a control plane, wherein the UUID uniquely identifies the multicast distribution tree irrespective of transport‐layer label assignments. The steps can further include linking the UUID to a multicast group and source address for RPF checking, wherein the control plane creates a multicast route entry that includes the UUID for validating incoming packets. The steps can further include mapping the transport identifier to the assigned UUID in the control plane, wherein the network device stores the mapping in a hardware or software table accessible to a data plane. The steps can further include programming a label forwarding table or incoming label map (ILM) with the mapping of the transport identifier to the UUID, wherein a data plane references the ILM to retrieve the second UUID for incoming packets.

The receiving the multicast packet can include detecting an MPLS label as the transport identifier, and the steps further include removing the MPLS label before performing UUID comparison in the VRF table. The steps can further include updating a UUID‐to‐transport‐identifier mapping in response to route convergence or other network changes, thereby maintaining consistent RPF checks across varying paths. The network device can be an egress provider edge (PE) router in a multicast virtual private network (VPN), and the VRF table is associated with a particular VPN instance, such that the UUID also differentiates multiple multicast trees in a same underlay.

The forwarding the multicast packet can further include replicating the multicast packet to one or more downstream nodes, and discarding the multicast packet can include performing a drop action upon detecting a UUID mismatch to prevent routing loops or duplicate traffic. The steps can further include generating in a control plane a programmable instruction linking the transport identifier, an assigned UUID, and a hardware identifier for line‐rate lookups; and installing the programmable instruction into a data plane via a hardware abstraction layer (HAL) or software development kit (SDK), wherein the data plane enforces UUID‐based RPF checks at forwarding time. The steps can further include storing the assigned UUID in a software layer of the network device, wherein upon receiving the multicast packet, the data plane consults a hardware table that references the UUID to execute the RPF check at line rate.

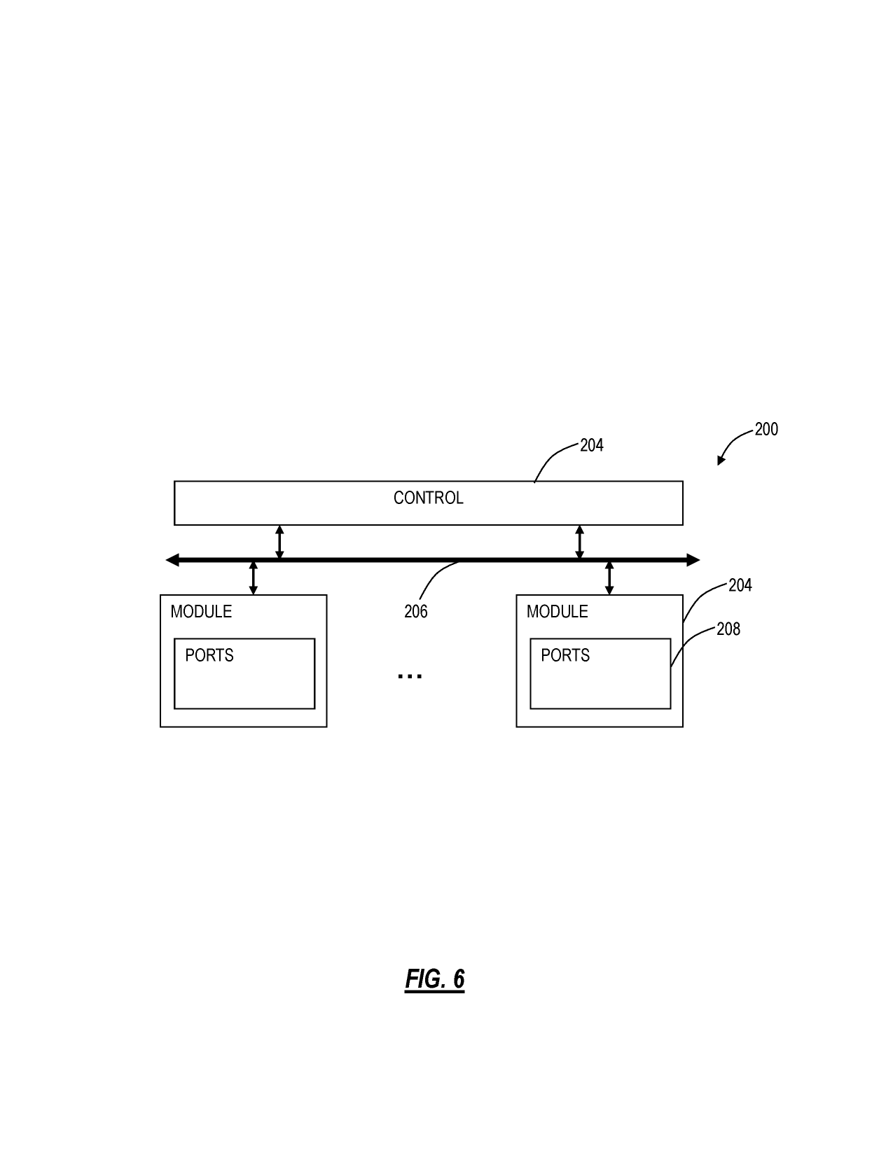

FIG. 6 illustrates a block diagram of a router 200, depicted in a simplified functional format. It is important to note that a more practical design of this router would likely include additional components and processing logic to accommodate standard operating features, which are not detailed here. The router 200 may represent any network element operable in a network using optical and packet protocols, and includes various interconnected modules, such as modules 204, 204, via an interface 206, such as a backplane, midplane, cabling, etc. These modules, also known as blades or line cards, are typically mounted on the chassis. Each module 204, 206 can house numerous electronic or optical devices on a circuit board, complete with various interconnects, including interfaces to the chassis itself.

Specifically, the diagram illustrates two types of modules: line modules 200, which feature multiple ports 208 for external connections, and a control module 204. The line modules 202 facilitate data traffic switching between ports 208 via a switching fabric, which can be integrated across the modules 202, potentially centralized in a separate unit or module (not shown), as well as a combination. This switching fabric includes hardware, software, and firmware that routes data between the ports 208. The control module 204 is equipped with processing circuity, memory, software, and a network interface to manage operations such as configuration and monitoring of the router 200. It may also communicate with external network management systems or databases that handle provisioning and operational data.

Lastly, while FIG. 6 provides a basic view, those skilled in the art will understand that the router 200 could include additional components or be configured differently, such as in a distributed arrangement or as an integrated, rack-mounted unit (often referred to as a "pizza-box" configuration). This depiction in FIG. 6 is intended to convey functional aspects, with actual hardware implementations varying widely. In an embodiment, the router 200 can be any of the network elements described herein, including the roots 1, 2, P nodes 1, 2, egress nodes 1, 2, 3, the PE node 20, etc. In another embodiment, the router 200 can implement the provisioning model 50, the process 100, etc.

In a further embodiment, the router 200 can be a network device configured to perform a reverse path forwarding (RPF) check for a multicast packet. Here, the router 200 include circuitry configured to receive a multicast packet that includes a transport identifier associated with a multicast distribution tree, retrieve a universally unique identifier (UUID) corresponding to the transport identifier, compare the retrieved UUID to a second UUID in a multicast routing entry of a virtual routing and forwarding (VRF) table, and forward the multicast packet if the retrieved UUID matches the second UUID, or discard the multicast packet otherwise, wherein the UUID provides an abstract handle for the multicast distribution tree independent of a physical interface or an Internet Protocol (IP) next‐hop.

Additionally, those skilled in the art will recognize that the various embodiments may include processing circuitry of various types. The processing circuitry might include, but are not limited to, general-purpose microprocessors; central processing units (CPUs); digital signal processors (DSPs); specialized processors such as network processors (NPs) or network processing units (NPUs), graphical processing units (GPUs); field programmable gate arrays (FPGAs); programmable logic device (PLD), or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more application-specific integrated circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each equipped with processing circuitry. These instructions, when executed, enable the system to perform the functions as delineated and claimed in this document. Such non-transitory computer-readable storage mediums can include, but are not limited to, hard disks, optical storage devices, magnetic storage devices, read-only memory (ROM), programmable read-only memory (PROM), erasable programmable read-only memory (EPROM), electrically erasable programmable read-only memory (EEPROM), flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

### Conclusion

In this disclosure, including the claims, the phrases “at least one of” or “one or more of,” when referring to a list of items, encompass any combination of those items, including any single item. For example, the expressions “at least one of A, B, or C,” “at least one of A, B, and C,” “one or more of A, B, or C,” and “one or more of A, B, and C” cover the possibilities of only A, only B, only C, any combination of A and B, A and C, B and C, or all three (A, B, and C). This also includes scenarios involving more or fewer elements than A, B, and C. Additionally, the terms “comprise,” “comprises,” “comprising,” “include,” “includes,” and “including” are intended to be open-ended and non-limiting, specifying essential elements or steps without excluding additional elements or steps - even where a claim or multiple claims contain more than one such term.

It should be understood that the drawings, descriptions, and examples provided herein merely illustrate various aspects and embodiments of the disclosure. Numerous modifications, changes, or arrangements may be made without departing from the spirit and scope of the disclosure. Although certain steps, operations, instructions, blocks, or similar elements (collectively referred to as “steps”) are depicted or described in a specific order, such ordering is not necessarily required unless explicitly stated. Nor does it imply that all depicted steps are essential to achieve the desired results. Extra steps may be performed before, after, concurrently, or interspersed with the illustrated or described steps. Multitasking, parallel processing, and other types of concurrent execution are also contemplated. Further, the separation of system components or steps described should not be interpreted as mandatory in all implementations; such components, steps, or elements may be integrated into a single configuration or distributed across multiple ones.

While this disclosure has been shown and described through specific embodiments and examples, those skilled in the art will recognize that many variations and modifications can provide equivalent functionality or yield comparable results. Such alternative embodiments and variations, even if not explicitly mentioned here, fall within the spirit and scope of this disclosure if they achieve the stated objectives and adhere to the underlying principles. Accordingly, they are envisioned and encompassed by the disclosure and protected by the associated claims. In other words, the present disclosure anticipates combinations and permutations of the described elements, operations, steps, methods, processes, algorithms, functions, techniques, modules, and circuits in any feasible sequence or arrangement - whether collectively, separately, or in subsets - thereby broadening the range of potential embodiments.

What is claimed is:

1. A method of performing a reverse path forwarding (RPF) check for a multicast packet in a network device, the method comprising steps of:
receiving a multicast packet that includes a transport identifier associated with a multicast distribution tree;
retrieving a universally unique identifier (UUID) corresponding to the transport identifier;
comparing the retrieved UUID to a second UUID in a multicast routing entry of a virtual routing and forwarding (VRF) table; and
forwarding the multicast packet if the retrieved UUID matches the second UUID, or discarding the multicast packet otherwise, wherein the UUID provides an abstract handle for the multicast distribution tree independent of a physical interface or an Internet Protocol (IP) next‐hop.

2. The method of claim 1, wherein the steps further include
prior to the receiving, assigning the UUID to the multicast distribution tree in a control plane, wherein the UUID uniquely identifies the multicast distribution tree irrespective of transport‐layer label assignments.

3. The method of claim 2, wherein the steps further include
linking the UUID to a multicast group and source address for RPF checking, wherein the control plane creates a multicast route entry that includes the UUID for validating incoming packets.

4. The method of claim 2, wherein the steps further include
mapping the transport identifier to the assigned UUID in the control plane, wherein the network device stores the mapping in a hardware or software table accessible to a data plane.

5. The method of claim 1, wherein the steps further include
programming a label forwarding table or incoming label map (ILM) with the mapping of the transport identifier to the UUID, wherein a data plane references the ILM to retrieve the second UUID for incoming packets.

6. The method of claim 1, wherein the receiving the multicast packet includes detecting an MPLS label as the transport identifier, and the steps further include removing the MPLS label before performing UUID comparison in the VRF table.

7. The method of claim 1, wherein the steps further include
updating a UUID‐to‐transport‐identifier mapping in response to route convergence or other network changes, thereby maintaining consistent RPF checks across varying paths.

8. The method of claim 1, wherein the network device is an egress provider edge (PE) router in a multicast virtual private network (VPN), and the VRF table is associated with a particular VPN instance, such that the UUID also differentiates multiple multicast trees in a same underlay.

9. The method of claim 1, wherein the forwarding the multicast packet further includes replicating the multicast packet to one or more downstream nodes, and discarding the multicast packet includes performing a drop action upon detecting a UUID mismatch to prevent routing loops or duplicate traffic.

10. The method of claim 1, wherein the steps further include
generating in a control plane a programmable instruction linking the transport identifier, an assigned UUID, and a hardware identifier for line‐rate lookups; and
installing the programmable instruction into a data plane via a hardware abstraction layer (HAL) or software development kit (SDK), wherein the data plane enforces UUID‐based RPF checks at forwarding time.

11. The method of claim 10, wherein the steps further include
storing the assigned UUID in a software layer of the network device, wherein upon receiving the multicast packet, the data plane consults a hardware table that references the UUID to execute the RPF check at line rate.

12. A network device configured to perform a reverse path forwarding (RPF) check for a multicast packet, the network device comprising circuitry configured to:
receive a multicast packet that includes a transport identifier associated with a multicast distribution tree,
retrieve a universally unique identifier (UUID) corresponding to the transport identifier,
compare the retrieved UUID to a second UUID in a multicast routing entry of a virtual routing and forwarding (VRF) table, and
forward the multicast packet if the retrieved UUID matches the second UUID, or discard the multicast packet otherwise, wherein the UUID provides an abstract handle for the multicast distribution tree independent of a physical interface or an Internet Protocol (IP) next‐hop.

13. The network device of claim 12, wherein the circuitry is further configured to
prior to the packet being received, assign the UUID to the multicast distribution tree in a control plane, wherein the UUID uniquely identifies the multicast distribution tree irrespective of transport‐layer label assignments.

14. The network device of claim 12, wherein the circuitry is further configured to
program a label forwarding table or incoming label map (ILM) with the mapping of the transport identifier to the UUID, wherein a data plane references the ILM to retrieve the second UUID for incoming packets.

15. The network device of claim 12, wherein the multicast packet is received by detecting an MPLS label as the transport identifier, and the MPLS label is removed before UUID comparison in the VRF table.

16. The network device of claim 12, wherein the circuitry is further configured to
update a UUID‐to‐transport‐identifier mapping in response to route convergence or other network changes, thereby maintaining consistent RPF checks across varying paths.

17. The network device of claim 12, wherein the network device is an egress provider edge (PE) router in a multicast virtual private network (VPN), and the VRF table is associated with a particular VPN instance, such that the UUID also differentiates multiple multicast trees in a same underlay.

18. The network device of claim 12, wherein the multicast packet is forwarded by replicating the multicast packet to one or more downstream nodes, and the multicast packet is discarded by a drop action upon detecting a UUID mismatch to prevent routing loops or duplicate traffic.

19. The network device of claim 12, wherein the circuitry is further configured to
generate in a control plane a programmable instruction linking the transport identifier, an assigned UUID, and a hardware identifier for line‐rate lookups, and
install the programmable instruction into a data plane via a hardware abstraction layer (HAL) or software development kit (SDK), wherein the data plane enforces UUID‐based RPF checks at forwarding time.

20. A non-transitory computer-readable medium storing instructions for performing a reverse path forwarding (RPF) check for a multicast packet, the instructions, when executed, cause a network device to perform steps of:
receiving a multicast packet that includes a transport identifier associated with a multicast distribution tree;
retrieving a universally unique identifier (UUID) corresponding to the transport identifier;
comparing the retrieved UUID to a second UUID in a multicast routing entry of a virtual routing and forwarding (VRF) table; and
forwarding the multicast packet if the retrieved UUID matches the second UUID, or discarding the multicast packet otherwise, wherein the UUID provides an abstract handle for the multicast distribution tree independent of a physical interface or an Internet Protocol (IP) next‐hop.
